(19) United States
(12) Patent Application Publication
(10) Pub. No.: US 2016/0048798 A1
(43) Pub. Date: Feb. 18, 2016

(54) INVENTORY SENSOR

(71) Applicant: Tagnetics, Inc., Troy, OH (US)

(72) Inventors: Matthew J. Meyer, Versailles, OH (US); Jonathan Dennis York, Troy, OH (US); Ronald E. Earley, New Carlisle, OH (US)

(73) Assignee: Tagnetics, Inc., Troy, OH (US)

(21) Appl. No.: 14/922,307

(22) Filed: Oct. 26, 2015

Related U.S. Application Data
(63) Continuation-in-part of application No. 14/152,644, filed on Jan. 10, 2014.
Application No. 14/152,644 is a continuation-in-part of application No. 14/520,835, filed on Oct. 22, 2014.
Application No. 14/520,835 is a continuation-in-part of application No. 14/300,689, filed on Jun. 10, 2014.
Application No. 14/300,689 is a continuation-in-part of application No. 14/262,927, filed on Apr. 28, 2014, now Pat. No. 9,022,637.
Application No. 14/262,927 is a continuation-in-part of application No. 14/217,902, filed on Mar. 18, 2014.
(60) Provisional application No. 61/751,649, filed on Jan. 11, 2013.

(51) Int. Cl. G06Q 10/08; G01G 19/414; G01G 19/42

(52) U.S. Cl. CPC G06Q 10/087; G01G 19/42; G01G 19/4144

(57) ABSTRACT

An inventory sensor for monitoring the inventory status at one or more retail shelves. The inventory sensor may comprise a mat and a plurality of opposing contact pairs. The mat is adapted to be disposed on a retail shelf with a forward edge of the mat facing the front of the retail shelf. The plurality of opposing contact pairs are arranged into a plurality of regions within the mat, the regions being arranged forward to aft in the mat with the first region being disposed along the forward edge of the mat and subsequent regions being disposed sequentially further aft from said first region. The contact pairs are biased open and the closing of an opposing contact pair produces results in the production of an electrical signal associated with the closed opposing contact pair. A controller monitors the mat to determine retail item footprints.

### CROSS-REFERENCE TO RELATED APPLICATIONS

This application is a Continuation-in-Part of U.S. patent application Ser. No. 14/152,644 filed Jan. 10, 2014 which claims priority from U.S. Provisional Patent Application No. 61/751,649, filed on Jan. 11, 2013, the entirety of which are incorporated herein by reference. This application is further a Continuation-in-Part of U.S. patent application Ser. No. 14/520,835 filed Oct. 22, 2014, which is a Continuation-in-Part of U.S. patent application Ser. No. 14/300,689 filed Jun. 10, 2014, which is a Continuation-in-Part of U.S. patent application Ser. No. 14/262,927 filed Apr. 28, 2014, which is a Continuation-in-Part of U.S. patent application Ser. No. 14/217,902 filed Mar. 18, 2014, the entirety of which are incorporated herein by reference.

### FIELD OF THE INVENTION

The present disclosure generally relates a system and apparatus for inventory control of retail products. More specifically, the present disclosure is directed to a system and apparatus that uses weight and/or contact sensors to measure inventory of retail products on the shelf of a retailer, tracks the purchasing of the retail products, captures inventory depletion rates, issues alerts and applies predictive algorithms to effectively manage inventory.

### BACKGROUND

A perennial challenge among retailers around the world is effective inventory management. Although retailers bear the consequences of this challenge in the form of lost sales or eroded customer loyalty, the entire supply chain is implicated. A product may go out of stock at the retailer's shelf due to failure to replenish products at the shelf, improper volume control at the store, poor demand forecasting, problems with distributional logistics, and complications at the manufacturing center.

One manifestation of this challenge to effectively control inventory of retail products is the failure to timely detect and correct when a retail product is “out of stock” on a shelf. In the United States alone retailers lose an estimated 4% of annual sales due to this problem. Lost sales are only one aspect of this problem; customers also become frustrated when an product they need is not available, eroding customer satisfaction and loyalty to retailers.

In most retail stores, out of stocks are detected only when a store employee visually identifies that an product is no longer stocked on the shelf. The employee must then record the product needed, find the product in the storage or warehouse area of the store, and re-stock the product. This process is time-consuming, costly, and inefficient. The process is particularly inefficient because a substantial amount of time may pass between the last product being removed from the shelf and identification of the out of stock product by a store employee.

A second manifestation of this challenge is the overstocking of shelves in a retail store. Many retailers fail to optimize the allocation of shelf space for their products, resulting in some products being stocked on a shelf at a volume such that the product would not sell out for several days or even weeks. This practice wastes valuable retail shelf space and creates an inventory glut of some products, which increases the inventory cost or holding cost of a retailer.

A third manifestation of the challenge of effective inventory management is out of place inventory. It is not uncommon for customers to change their purchasing decisions during shopping, sometimes returning products to shelves not designated for the returned product. This may result in lost inventory, spoilage, and/or and unnecessary restocking of the product.

There is thus a well-established desire in the field of retail inventory control to implement a new system or apparatus for improving the inventory control and management of retail products. More specifically, there is a demand among retailers for a system or apparatus capable of optimizing at-the-shelf inventory of retail products, predicting when an product may go out of stock, identifying out of place inventory, and notifying the retailer in sufficient time to avoid the problems associated with out of stock inventory identified above.

### SUMMARY

In accordance with one embodiment, a weight sensing system is provided in a shelf system that supports products for sale in a retail store. The sensing system includes multiple shelves having an electrical communication and power distribution system, and weight sensors located on the top surfaces of the shelves and coupled to the electrical communication and power distribution system for detecting the placement of retail products on the shelves. Each sensor includes first and second arrays of electrical conductors on the upper surface of a shelf, portions of the conductors in the first and second arrays being positional vertically adjacent and slightly spaced from each other at multiple spaced locations throughout a selected area of the shelf surface. The conductors in at least one of the arrays are flexible so that the weight of a product on the shelf in the selected area presses a flexible conductor in at least one array into contact with the adjacent portion of a conductor in the other array. An electrical power source is coupled to the conductors for applying a voltage across the first and second arrays, and a controller detects when current flow or voltage changes between the first and second arrays because none of the adjacent portions of the conductors in the first and second arrays are in contact with each other.

In one implementation, the adjacent portions of the conductors are biased away from each other so that they do not contact each other in the absence of any weight on the upper conductor. For example, the conductors of the two arrays may be printed on a resilient polymeric sheet, with a spacer between the sheets so that the resilience of the sheets spaces the adjacent portions of the conductors from each other in the absence of any weight on the sheets.

In another implementation, an inventory control system is disclosed which monitors inventory levels and out of stock items, generates alert signals for retail store employees based on low inventory levels or out of stock conditions, measures depletion rates of products, and generates inventory reports.

In accordance with some embodiments of the present disclosure an inventory sensor is provided. The inventory sensor may comprise a mat and a plurality of opposing contacts pairs. The mat is adapted to be disposed on a retail shelf with a forward edge of the mat being adapted to substantially align with the front of the retail shelf. The plurality of opposing contact pairs are arranged into a plurality of regions within the mat, the regions being arranged forward to aft in the mat with the first region being disposed along the forward edge of the map and subsequent regions being disposed sequentially further aft from said first region. The contact pairs are biased open and the closing of an opposing contact pair produces results in the production of an electrical signal associated with the closed opposing contact pair.

In accordance with some embodiments of the present disclosure an inventory sensor is provided. The sensor comprises a plurality of opposing contact pairs wherein each opposing contact pair comprises a first contact disposed in a first layer and a second contact disposed in a second layer. Each contact pair is biased such that the first contact and second contact are not electrically connected. The biasing is provided by a third layer disposed between the first and second layers. The first contact of each pair is electrically connected to one of a plurality of supply lines and the second contact of each pair is electrically connected one of a plurality of return lines. Each of the first contacts, second contacts, supply lines and return lines are formed from a conductive material, such that brining one of the first contacts and second contacts into electrical connection with form a closed circuit comprising the supply line, the first contact, the second contact, and the return line. The first lay, second layer, and third layer collectively form a mat having a forward edge adapted to be disposed along a front edge of a shelf. The plurality of opposing contacts are arranged into plurality of regions in the mat wherein the regions are arranged transverse to a forward-aft axis of the mat.

In accordance with some embodiments of the present disclosure an inventory control system is provided. The system comprises a first, second, and third contact sensors. The first contact sensor comprises a first supply line, a first top contact, a first bottom contact, and a first return line. The first supply line supplies a positive voltage to said first top contact which is disposed above but disconnected from said first bottom contact. The bottom contact is connected to said first return line. The second contact sensor comprises a second supply line, a second top contact, a second bottom contact, and a second return line. The second supply line supplies a positive voltage to said second top contact which is disposed above but disconnected from said second bottom contact. The bottom contact is connected to said second return line. The third contact sensor comprises a third supply line, a third top contact, a third bottom contact, and a third return line. The third supply line supplies a positive voltage to said second top contact which is disposed above but disconnected from said third bottom contact. The bottom contact is connected to said third return line. The first, second and third contact sensors are disposed within a mat with the first contact sensor disposed in a forward portion of the mat, the second contact sensor disposed in a central portion of the mat, and the third contact sensor disposed in an aft portion of the mat. Each top contact and bottom contact of said first, second, and third contact sensors are adapted to move into electrical connection when a force is applied adjacent to either of the top contact and bottom contact.

In accordance with some embodiments of the present disclosure an inventory control system is provided. The inventory control system may comprise a sensor and an electronic shelf label. The sensor may comprise a mat and a plurality of opposing contacts pairs. The mat is adapted to be disposed on a retail shelf with a forward edge of the mat being adapted to substantially align with the front of the retail shelf. The plurality of opposing contact pairs are arranged into a plurality of regions within the mat, the regions being arranged forward to aft in the mat with the first region being disposed along the forward edge of the map and subsequent regions being disposed sequentially further aft from said first region. The contact pairs are biased open and the closing of an opposing contact pair produces results in the production of an electrical signal associated with the closed opposing contact pair. The electrical signal is transmitted the processor of the electric shelf label, which interprets the signal to determine the inventory status of the shelf monitored by the sensor. This determined inventory status may be further transmitted to a store controller or other central inventory system.

In accordance with some embodiments of the present disclosure an inventory control system is provided. The system comprises one or more stores, one or more district or regional warehouses, a central office, and may comprise one or manufacturers or suppliers. Each of the one or more stores comprises a series of retail and or storage shelves upon which an inventory sensor is disposed. Products placed on the sensor will close a pair of contacts within the sensor which provide an electrical signal that a product is present. This electrical signal may be interpreted, modified and transmitted as an inventory status to a central office and/or the district or regional warehouse to indicate the shelf and store inventory status and to order new products. Additionally, the district warehouse may employ the warehouse inventory sensor to monitor the inventory status at the warehouse. This warehouse inventory status may be transmitted to the central office and/or stores. The central office may gather the inventory status of each store and warehouse and transmit the total inventory status to one or more manufactures and/or suppliers to order new inventory.

In accordance with some embodiments of the present disclosure an inventory sensor comprises a plurality of first conductive elements, each disposed in a first layer and connected to an electrical supply line, a plurality of second conductive elements, each disposed in a second layer and aligned such that each second conductive element opposes one of the plurality of first conductive elements, each second conductive element connected to a unique electrical return line, wherein each of the plurality of first conductive elements are adapted to move into contact with the respective opposing second conductive element when force is applied to the first conductive element in the direction of second conductive element and wherein the electrical supply line and the unique electrical return line for each of the plurality of second conductive elements are connected to a controller which monitors each unique electrical return line to determine a footprint associated with a retail item placed on the inventory sensor, and wherein the controller compares the determined footprint to a database of stored retail item footprints to identify the retail item placed on the inventory sensor.

In some embodiments the controller monitors each unique electrical return line to determine a quantity of footprints associated with the retail items placed on the inventory sensor. In some embodiments the controller additionally determines the weight of the retail items placed on the inventory sensor. In some embodiments the controller compares the determined retail item weight to a database of stored retail item weights to determine a quantity of retail items placed on the inventory sensor. In some embodiments the controller performs a lookup in the database for the identified retail items to determine a predetermined low inventory threshold associated with the retail item and generates a warning when the determined quantity falls below the predetermined low inventory threshold. In some embodiments the controller monitors each unique electrical return line to determine a quantity of footprints associated with the retail items placed on the inventory sensor and wherein the quantity of footprints, the determined retail item weight, and the determined quantity of retail items are cross-referenced to identify an out of place retail item condition. In some embodiments a visual indication is generated at the inventory sensor or at an associated display when a retail item having a non-matching footprint or non-matching weight is detected at the controller on the inventory sensor. In some embodiments the inventory sensor further comprises a third layer disposed between the first layer and the second layer to provide biasing such that each of the plurality of first conductive elements and each of the plurality of second conductive elements are not in contact when force is not applied to the first conductive element in the direction of second conductive element.

In accordance with some embodiments of the present disclosure an inventory sensor comprises a plurality of opposing contact pairs, each opposing contact pair comprising a first contact disposed in a first layer and a second contact disposed in a second layer, wherein each opposing contact pair is biased such that the first contact and the second contact are not connected, the biasing provided by a third layer disposed between the first layer and the second layer, wherein each of the plurality of first contacts is electrically connected to one of a plurality of supply lines and each of the plurality of second contacts is electrically connected to one of a plurality of return lines, wherein each of the first contacts, the second contacts, the supply lines and the return lines are formed from conductive material, such that bringing one of the first contact and one of the second contact into connection forms a conductive path comprising the supply line, the first contact, the second contact, and the return line, wherein the first layer, the second layer, and the third layer collectively form a mat having a forward edge facing a front edge of a shelf, with the plurality of opposing contact pairs arranged into a plurality regions in the mat, the plurality of regions arranged transverse to a forward-aft axis of the mat, and wherein each of the plurality of supply lines and each of the plurality of return lines are connected to a processor for determining a footprint associated with a retail item placed on the mat.

In some embodiments the processor determines in which region of the plurality of regions the retail item is located. In some embodiments the processor determines a quantity of footprints associated with the retail items placed on the mat. In some embodiments the processor compares the determined footprint to a database of stored retail item footprints to identify the retail item placed on the mat. In some embodiments the processor transmits the determined quantity of retail item footprints to a display associated with the mat. In some embodiments each of the plurality of second contacts is electrically connected to one of a plurality of return lines which is unique to that second contact. In some embodiments the third layer comprises a granulated material adapted to permit air flow between opposing contacts of opposing contact pairs. In some embodiments the processor is disposed within an electronic shelf label electrically connected to the mat. In some embodiments the bringing one of the first contact and one of the second contact into connection to form a conductive path is caused by placing a retail item on the mat. In some embodiments the processor generates a warning for store personnel when the determined quantity of retail item footprints falls below a predetermined threshold. In some embodiments the processor generates an alarm for store personnel when the determined quantity of retail item footprints is zero. In some embodiments the processor is disposed with the mat, and wherein the processor is inductively coupled to an inventory control system.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a front perspective of an exemplary configuration of a retail store shelf system in which each shelf includes one or more out-of-stock sensors coupled to an electrical power and communication system traversing the shelf.

FIG. 2 is an enlarged front perspective of one segment of one of the shelves in the system of FIG. 1.

FIG. 3 is an exploded perspective of the shelf segment shown in FIG. 2.

FIG. 4 is an enlarged and exploded vertical section of one of the sensing areas in the out-of-stock sensor included in the shelf segment shown in FIGS. 1-3.

FIG. 5 is a further enlargement of the central portion of the vertical section shown in FIG. 4, not exploded and with the electrical contacts in the sensing area in their open positions.

FIG. 6 is the same vertical section shown in FIG. 5, with the electrical contacts in the sensing area in their closed positions.

FIG. 7 is a front perspective similar to that shown in FIG. 2, with a modified version of the out-of-stock sensor.

FIG. 8 is a simplified illustration of one embodiment of the present disclosure of a sensor with multiple programmable regions.

FIG. 9 is a simplified illustration of one embodiment of the present disclosure of a programmable shelf label.

FIGS. 10A and 10B are simplified illustrations of some embodiments of the present disclosure of programmable shelf labels.

FIG. 11 is a flow chart of a method of inventory control in accordance with some embodiments.

FIGS. 12A, 12B and 12C are schematic diagrams of inventory control systems in accordance with some embodiments of the present disclosure.

FIG. 13 is a perspective view of a sensor in accordance with some embodiments of the present disclosure.

FIGS. 14A and 14B are a separated view of an interface between an electronic shelf label and a sensor in accordance with some embodiments of the present disclosure.

FIG. 15 is a diagram of an inventory control system in accordance with some embodiments of the present disclosure.

FIGS. 16A, 16B, and 16C are diagrams of a sensor divided into multiple regions in accordance with some embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present disclosure is directed to a system and apparatus for inventory control of retail products. A weight sensor configured to be disposed on a retail shelf is operatively connected to a controller, which monitors retail product inventory based on the sensed product weight at the shelf.

As used in this disclosure, a weight sensor may refer to a sensor capable of measuring the weight of an item or a sensor which uses the weight of an item to detect the presence of it. In some embodiments, this will require a minimum item weight. The weight sensor need not be able to measure the weight of an item. As used herein, the weight sensor need only to detect the presence of an item. For example, the weight sensor may be able to sense the footprint of a product placed on the sensor. The sensed footprint of a product, alone, or in combination with a measured weight, can assist in determining the inventory on the sensor, including out of place products. At any point in the disclosure, the particular meaning of the term weight sensor will be apparent from the context in which it is used.

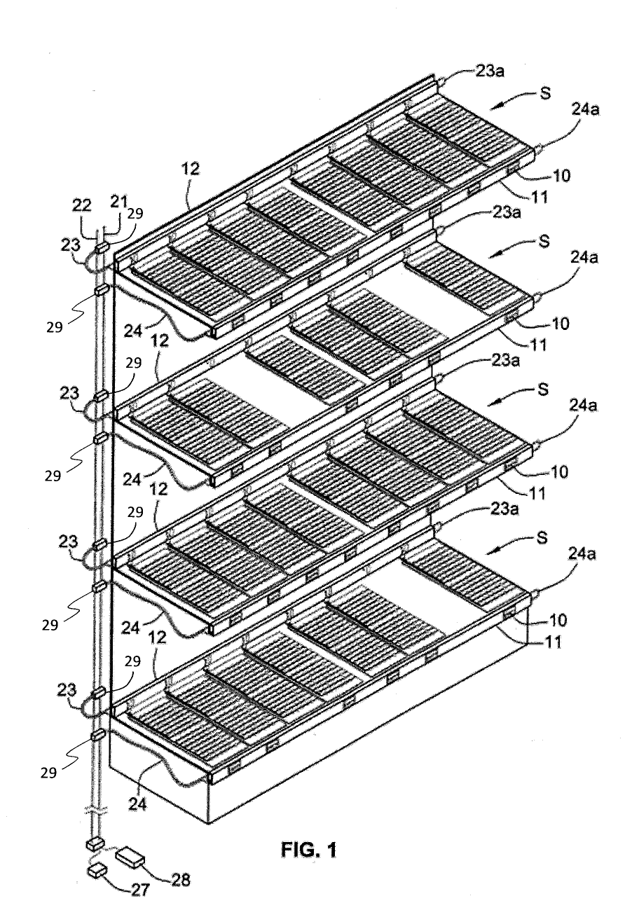

FIG. 1 is a front perspective of one example of an inventory control system for retail products. FIG. 1 illustrates a bank of shelves S of the type typically used by retail stores for stocking and displaying a multiplicity of products to customers, in a manner that the customer can conveniently remove any selected product from the shelf on which that product is stocked. In the illustrated embodiment, each shelf S is equipped with an electrical communication and power distribution system that is coupled to electronic shelf labels 10 mounted on a rail 11 extending along the front edge of each shelf S and coupling coils mounted inside a rail 12 extending along the rear edge of each shelf S.

A pair of conductors 21 and 22 extending upwardly along the shelves S connect both an electrical power source 27 and a controller 28 to multiple connectors 29 spaced along the length of the conductors 21 and 22. In some embodiments connectors 29 comprise transformers; in other embodiments, connectors comprise direct electrical connections. A pair of connectors 29 is provided for each shelf S, for carrying both power and communication signals to a pair of loops 23a and 24a that extend along the rear and front edges, respectively, of each shelf S. These loops 23a and 24a function as a pair of primary windings electromagnetically coupled to multiple secondary windings 23b and 24b spaced along the length of respective rails 12 and 11 extending along the rear and front edges, respectively, of each shelf S. These primary and secondary windings form multiple transformers that couple both power and communication signals between the rear loop 23a and weight sensors 30 on the top surfaces of the shelves S, and between the front loop 24a and the electronic shelf labels (ESLs) 10 on the rails 11 on the front edges of the shelves S. These transformers are referred to as “inductive coupling” or “inductively coupled connections.”

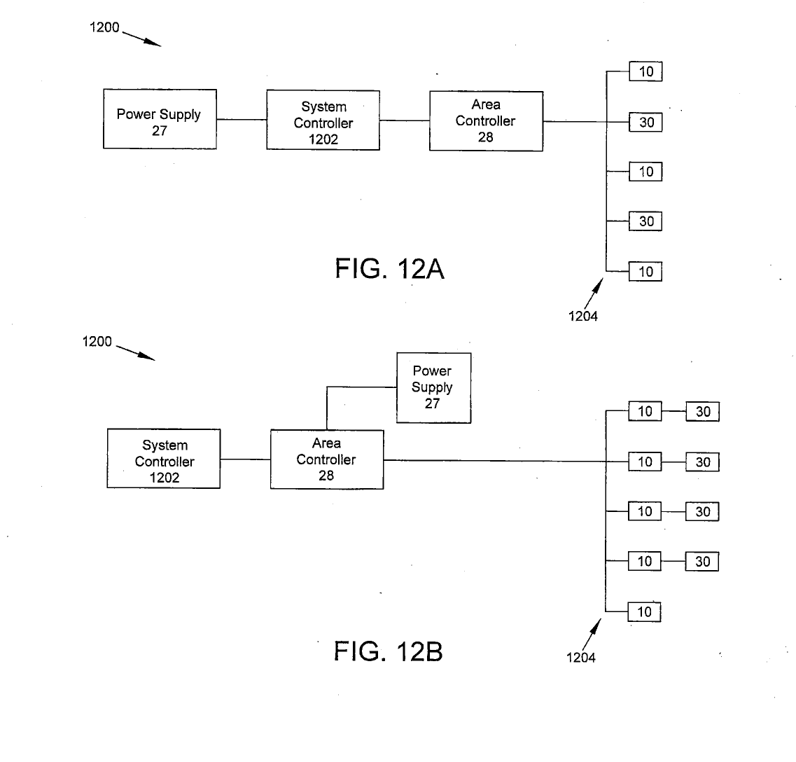

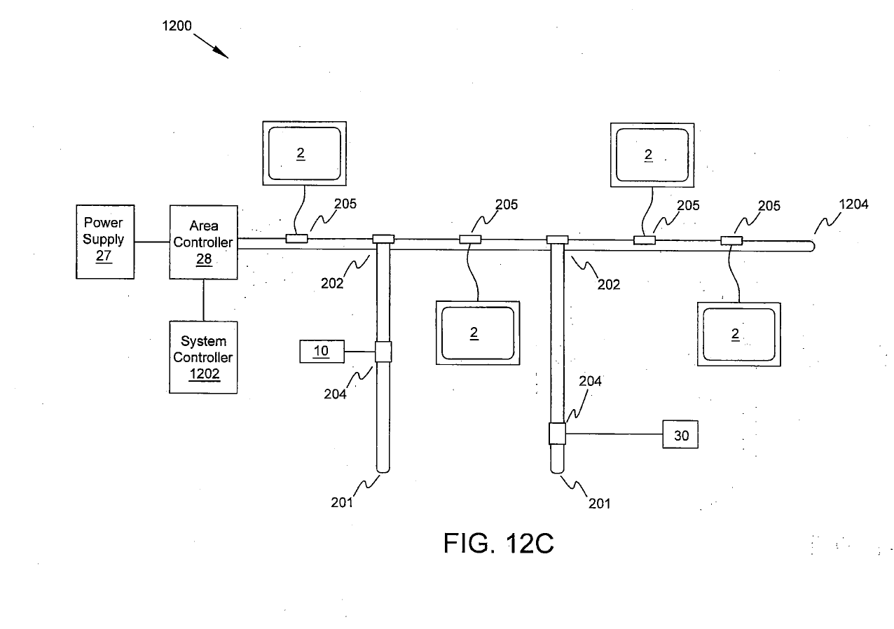

FIGS. 12A-C are schematic diagrams of inventory control systems 1200 in accordance with some embodiments. Weight Sensors 30 and ESLs 10 are disposed on retail shelves (not shown) throughout a retail store and connected in a system 1200. In some embodiments, the system 1200 comprises a plurality of weight sensors 30, ESLs 10, at least one area controller 28, a system controller 1202, a power supply 27, and a distribution loop 1204. In some embodiments, distribution loop 1204 comprises conductors 21, 22. In some embodiments, the system controller 1202 controls a plurality of area controllers 28, with each area controller 28 responsible for controlling a plurality of weight sensors 30 and ESLs 10 in a specific area of a retail store. For example, in some embodiments a retail store is assigned a single system controller 1202 while a separate area controller 28 is assigned for each aisle in the retail store. This would enable an employee to use a single user interface at the system controller 1202 to control any or all of the area controllers 28 and the respectively assigned weight sensors, ESLs and other components. In some embodiments, the power supply 27, area controller 28, system controller 1202, and distribution loop 1204 are referred to as a power distribution and communications system or subsystem.

In some embodiments, as illustrated in FIG. 12A, power supply 27 is operatively connected to system controller 1202, which is operatively connected to area controller 28. Area controller is further operatively connected to a plurality of weight sensors 30 and ESLs 10 via a distribution loop 1204.

In some embodiments, as illustrated in FIG. 12B, power supply 27 is operatively connected to area controller 28, which is operatively connected via the distribution loop 1204 to ESLs 10. The ESLs 10 are further connected to the weight sensors 30. Area controller 28 is further operatively connected to system controller 1202. The area controller 28 sends and receives communication signals with the system controller 1202. These components may also send and receive power signals from one another. In some embodiments, system controller 1202 is wirelessly connected to area controller 28.

FIG. 12C is a schematic diagram of an inventory control system 1200 comprising at least one weight sensor 30 and ESL 10 in accordance with some embodiments. The inventory control network 1200 distributes power and communication signals to and from weight sensors 30 and ESLs 10. These communication signals may control the weight sensors and process by which the display of each ESL 10 is driven. In some embodiments, inventory control system 1200 distributes power to a plurality of video monitors 2, or other components such as promotion displays and inventory sensors.

In some embodiments power supply 27 is a standard wall outlet well known in the art. Electrical power flows through an area controller 28 to a power stringer 1204. In some embodiments the area controller 28 is a power Tag Area Controller. In some embodiments the power stringer 1204 is called the primary distribution loop. In some embodiments power stringer 1204 distributes power signals between 45 and 50 VAC, 50 KHz, and 1 ampere. A frequency of 50 KHz was selected in part to comply with applicable regulatory requirements.

Power stringer 1204 conveys communication and power signals from the area controller 28 to at least one weight sensor 30 and ESL 10. In some embodiments, power stringer 1204 additionally conveys power to at least one secondary distribution loop 201. A secondary distribution loop 201 may also be referred to as a riser. Each weight sensor 30 is connected to the power stringer 1204 or a secondary distribution loop 201 via a power coupler 204. Each video monitor 2 is connected to the power stringer 1204 via a power converter 205. Each secondary distribution loop 201 is connected to power stringer 1204 via a primary-secondary connection 202. In some embodiments, the primary-secondary connection 202 is a step-down transformer which maintains the secondary distribution loop 201 at a lower voltage, frequency, and/or amperage than the power stringer 1204. In other embodiments, the primary-secondary connection 202 maintains the secondary distribution loop 201 at the same voltage, frequency, and/or amperage as power stringer 1204.

In some non-limiting embodiments, power converter 205 and power coupler 204 are those described in U.S. patent application Ser. No. 14/217,902.

In some embodiments, area controller 28 is a tag area controller as used in a system of electronic shelf labels such as that disclosed in U.S. Pat. Nos. 5,537,126; 5,736,967; 6,249,263; 6,271,807; and 6,844,821. In other embodiments, area controller 28 may be removed from inventory control system 1200 allowing each power converter 205 and power coupler 204 to connect to the power supply 27. In some embodiments, the area controller 28 is an electrical power strip. In some embodiments, the control of an area controller 28 is provided by a system controller 1202.

In some embodiments, a plurality of weight sensors 30 receive electrical power from a plurality of power supplies 27 or a plurality of low voltage power stringers 1204. In some embodiments, the weight sensor 30 may receive power from an onboard power source such as a battery, or may receive power via an external source either wired or wirelessly. Similarly, the ESL 10 display is driven by a communications signal transferred from the area controller 28, or alternatively the system controller 1202, through power stingers 1204 to power converts 205 or, alternatively, secondary distribution loop 201 and power couplers 204. In some embodiments these communication signals are received wirelessly or via some other wired communication protocol.

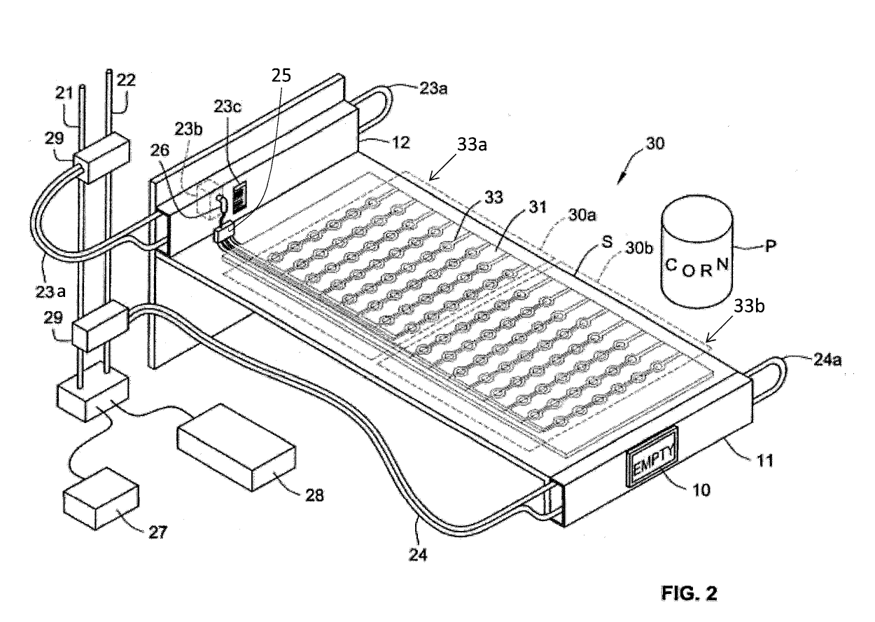

With reference to FIG. 2, the rear loop 23a may be coupled to multi-turn coils 23b spaced along the interior of the rear rail 12. Each of the coils 23a in the rear rail 12 may be coupled to an adjacent socket in the rail 12 for receiving a jack 26, which in turn is attached to a connector 25 that receives electrical leads from one or more weight sensors 30 on an adjacent area of the top surface of a shelf S. In the illustrative embodiment, the connector 25 receives four leads, two from a first sensor 30a on a rear region 33a of the adjacent shelf area, and two from a second sensor 30b on a front region 33b of the adjacent shelf area. The four leads may be used to supply power to the sensors 30a and 30b, and also to monitor the electrical current flowing through each sensor for detecting when the shelf areas covered by the respective sensors 30a and 30b have products on them, as discussed in detail below. The present disclosure may have sensors having multiple regions of different sizes and dimensions which can be established using various physical and electrical connections and/or separations between the regions. In another embodiment a single sensor may be selectively divided into regions through a programmable processor.

Rear rail 12 may include a UPC label 23c which uniquely identifies the weight sensor 30 in use at that shelf S. This UPC label 23c can be used to link the weight sensor 30 with the specific product P stocked on the weight sensor 30. Controller 28, or a similar computer processor, maintains a database of unique weight sensor 30 identifiers, printed on UPC label 23c, and the products P stocked thereon.

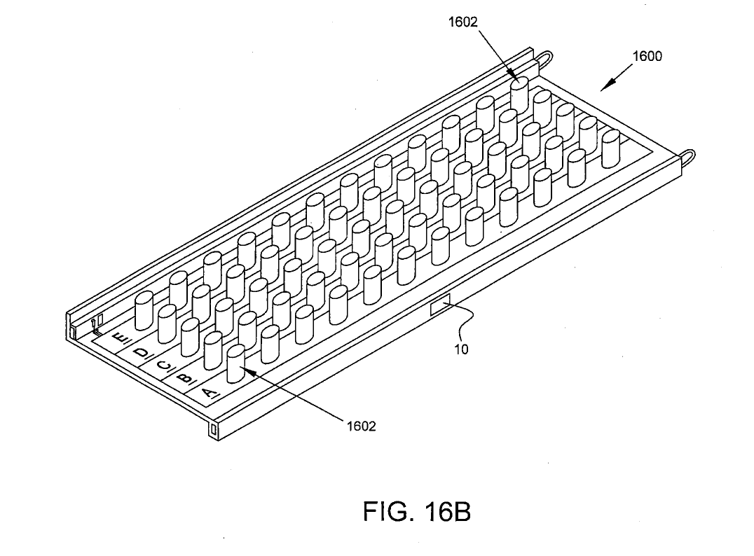

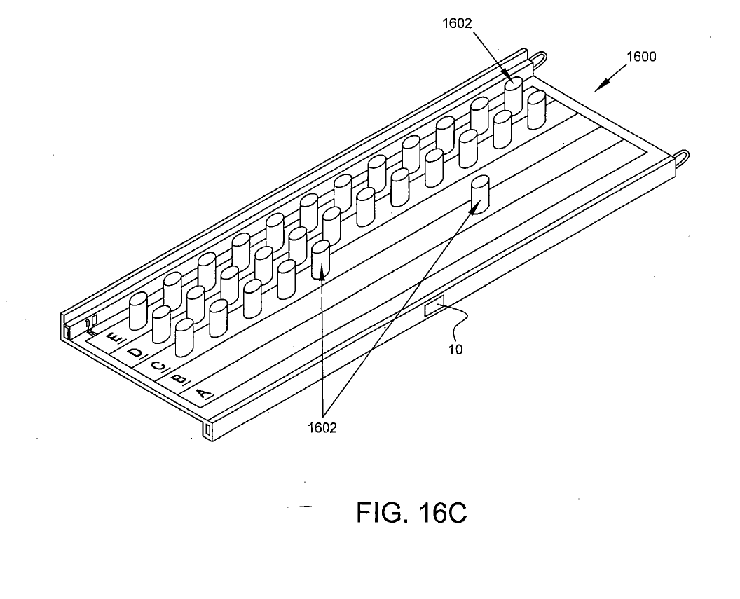

In some embodiments, the weight sensor may be divided into a plurality of regions. As shown in FIG. 16, the sensor 1600 is divided into a plurality of regions (as shown, five regions) A, B, C, D and E. In some embodiments, the regions are aligned transverse to an axis which runs from the front to rear (forward to aft) edge of the shelf. This axis may be referred to as a front-aft axis. Each region comprises a plurality of opposing contacts/contact switches (described above), each of which may be connected to a common electrical input lead (also referred to as a supply lead and/or line). The output of each region is connected to a shared electrical output lead (also referred to as a return lead and/or line) which is monitored by a processor. When one or more of the contact switches in region A closes (due to a force being applied adjacent to the closed switch, for example, by the weight of a product sent on top or nearly on top of the contact switch), a change in voltage or current flow can be detected. This change provides an output from the sensor 1600 indicating that at least one product is located on the shelf in region A. Similarly, a single shut contact in regions B, C, D and E will provide an indication that a product is located there.

Dividing the sensor 1600 in this manner allows better approximation of the percentage of products remaining on a shelf. So long as there is one contact shut in each of the six regions of the example above, the sensor 1600 will provide an indication that 100% of regions have products. When the last product is removed from region A (the region closest to the front edge of the shelf), any closed contact in region A will open, cutting the output current and/or voltage. The combined output of the sensor will then indicate that only 80% (or, in this example, four of the five regions) contain some number of products. For example, the shelf shown in FIG. 16B is fully stocked with product 1602. Since at least one product is located in each region, the inventory system will see a shelf inventory of 100%. As shown in FIG. 16C, as products are removed, some regions, here region A, will no longer contain products. In this figure region D and E are fully stocked, region C is partially stocked, region B has only one product, and region A contains no products. Since the four regions B, C, D and E each contain at least one product (and, therefore, at least one shut contact), the shelf inventory will read as 80%.

Sensor 1600 with front-aft regions A, B, C, D, and E is advantageous in that the status of each region (i.e. in stock or out of stock) can be separately communicated to store personnel such that it will become evident when products need to be moved forward on the shelf. For example, a warning can be provided to store personnel when region A is out of stock to alert personnel to pull product forward. In another embodiment, a warning is provided when regions A and B are out of stock to indicate that product should be pulled forward on the shelf. This sensor 1600 and warning system thus helps maintain shelves that appear fully stocked (i.e. with product aligned along the front of the shelf).

Sensor 1600 is also advantageously used in conjunction with a product pusher, a device known in the art to mechanically keep products aligned along the front of the shelf. A product pusher provides pressure against a row of products from the aft section of the shelf and pushes the products against a front retaining mechanism such that when the most forward product is removed from the front of the shelf, the remaining products slide forward until retained by the retaining mechanism When used in conjunction with sensor 1600 having front-aft regions A, B, C, D, and E, store personnel are able to more closely monitor product inventory which depletes first in region E and last in region A. A warning can be provided to store personnel, for example, when regions E and D are out of stock, which indicate that the total stock at the shelf of regions A, B, C, D, and E is becoming low. This warning will typically provide store personnel with sufficient lead time to re-stock the product before it becomes fully out of stock in all regions of sensor 1600.

In some embodiments, the senor regions are further divided into rows and columns, wherein the width of a column is equal to the width of the product on the shelf to provide even greater accuracy as to the percentage of a product on the shelf.

The present disclosure further provides a method for installing the disclosed weight sensor 30 and electronic shelf labels (ESL) 10 and associating both with a particular product. The weight sensor 30 and ESL 10 are connected to an inventory control network via inductive coupling to an area controller 28 which may be connected to or in communication with a system controller. The weight sensor 30 and ESL 10 are then automatically or manually assigned an address in the inventory control network. The inventory network may assign this address after detecting a new sensor 30 and/or ESL 10 being connected to a network. Additionally, the network may associate the new sensor 30 and/or ESL 10 with the particular connector 29 through which the deceives are detected. This connector 29 may be associated, in a database, with a particular location (e.g. aisle and/or shelf) within a store, thereby associating the sensor 30 and ESL 10 with the same location. In some embodiments, associating the sensor 30 and ESL 10 with a particular connecter 29 and/or location within the store may be performed manually at the area or system controller or with a mobile device.

In some embodiments, sensor 30, ESL 10 and retail shelves may be paired with one another by scanning a unique identifier (e.g., UPC, QR codes, etc.) of each with a mobile device in communication with the system and/or area controllers.

A user may link the sensor 30 and ESL 10 with a specific retail product by scanning the sensor 30 and/or ESL's unique identifier (e.g., barcode, QR code, or equivalent) and the product's UPC. If the sensor 30 and ESL 10 have already been paired, associating either with a product may also associate the other with the same product. The information scanned by the user is transmitted to the system controller 26, and/or area controller, wherein the system or area controller will associate the ESL 10 with the scanned product's UPC and store this association in memory. In some embodiments, this association may be stored in a database maintained off the premises of the retail store.

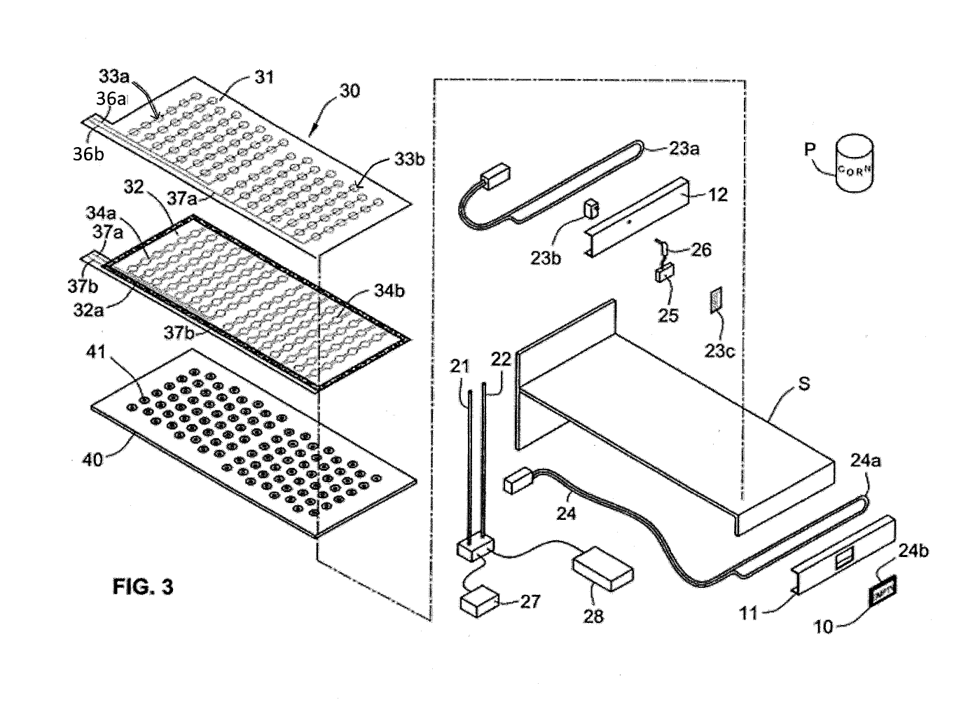

With reference to FIG. 3, the front loop 24a may be coupled to multi-turn secondary windings 24b on the rear sides of the electronic shelf labels 10 on the front rail 11. Each electronic shelf label 10 may include a display that is powered by the coil 24b on that label, and may be controlled by communication signals received via the coil 24b to display the price and other information related to the product P on the adjacent portion of the shelf S. In FIGS. 2 and 3, the product P is illustrated as cans of corn, as an example.

Each weight sensor 30 may include a laminate of two flexible sheets 31 and 32, such as plastic or fabric sheets, printed with patterns of a conductive material, such as aluminum. The two sheets 31 and 32 may be bonded together by adhesive 32a or other fastening means. The conductive patterns may be positioned on the lower surface of the upper sheet 31 and the upper surface of the lower sheet 32, so that they are directly opposite each other, on the opposed surfaces of the two sheets 31 and 32. As can be seen in FIGS. 2 and 3, the conductive patterns on both of the two sheets 31 and 32 form multiple rows of interconnected disc-shaped contacts 33 and 34, respectively, that cooperate with each other to form multiple pairs of opposed contacts. These contacts 33, 34 or conductive elements may be normally open, but can be closed by flexing one or both of sheets 31 and 32 to bring the contacts into engagement with each other. Different sizes and shapes for the conductive pattern may be used and can be selected as a function of the size and weight of the product to be placed on the sensor, and different materials may be selected for the conductive material so long as it is able to flex with the sheet it is embedded in.

Disc-shaped contacts 33 and 34 are arranged in rows on flexible sheets 31 and 32. Each row is connected to an electrical lead which is connected to connector 25. Rows of contacts are divided into regions: a rear region of first contacts 33a, a front region of first contacts 33b, a rear region of second contacts 34a, and a front region of second contacts 34b.

As illustrated in FIG. 3, each region of weight sensor 30 has a unique pair of electrical leads. Rear region 33a, 34a are connected to electrical leads 36a and 37a, respectively. Front region 33b, 34b are connected to electrical leads 36b and 37b, respectively.

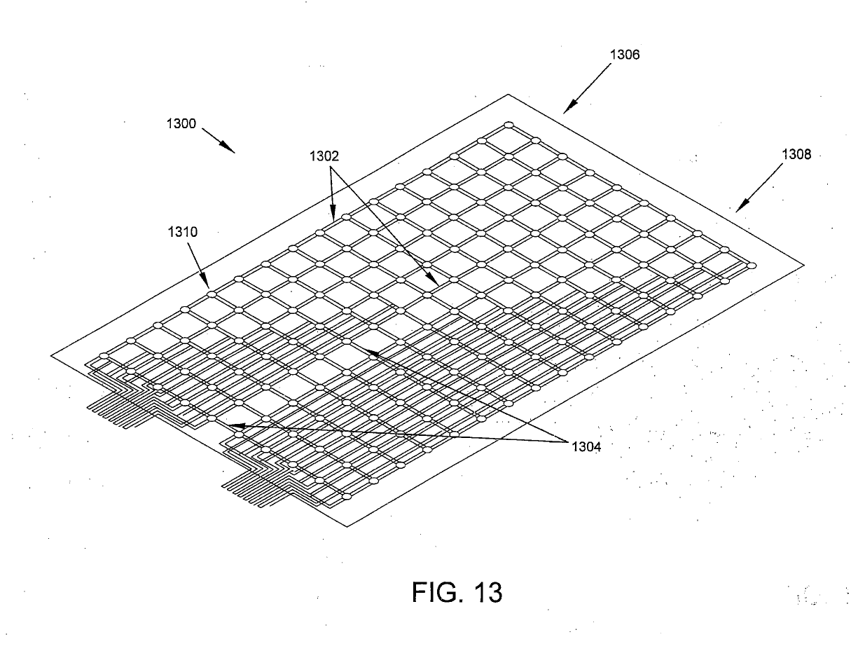

In some embodiments, the weight sensor 30 comprises a matrix of electrical conductors arranged in columns and rows to more accurately detect the footprint (or, area of the shelf covered by a product) thereby providing a more accurate indication of product inventory. An example of such a matrix is shown in FIG. 13. The weight sensor 1300 comprises a series of columns 1302 and rows 1304 arranged to intersect a plurality of contacts 1310. The contacts 1310 may be similar to those described above. When a product is placed on top of the weight sensor 1300, the weight of the product will cause the upper and/or lower sheets to bend causing a contact 1310 to shut. The closing of any contact 1310 produces a detectable current or change in voltage. Since the contacts in a given column are connected by common electrical conductors, the closing of any contact 1310 in a given column 1302 only provides the indication that a product is located somewhere along that column.

In some embodiments the sensor 1300 may be divided into one or more regions 1306,1308. Any size or shape of a region may be chosen by selecting the combination of rows and columns which define the desired region. The sensor may be divided into regions in order to allow multiple products to be placed on a single mat or to allow for inventory control to be determined on a regional basis while allowing simpler configurations of the sensor output. For instance, each region may be a single output electrical lead, such that the inventory system only determines when there is at least one product located in any region.

Greater accuracy of the size and location of a product can be obtained by supplementing the columns 1302 will a series of rows 1304 which intersect the contacts 1310. As shown in FIG. 13, each electrical conducting row 1304 is supplied by one or more electrical leads. The input electrical leads may supply a voltage to the row 1304 which produces a current flow or voltage change when a contact in a given row is shut. This current flow or voltage change may be detected on an output lead either separately from the column output lead or as an increase over that from the column input lead alone. In some embodiments, the input and output leads of the rows 1304 and column 1302 are separated from one another. Such an embodiment requires separate contacts for the rows or a more complex contact 1310 design which would separate the current flows between the rows and columns In some embodiments, the rows and columns terminate in a common output lead. In such embodiments, the input voltage/current for each subsequent row may be given an increasingly large input voltage over the previous row. For example, the first, second and third rows could be supplied with a voltage of 3.1, 3.3, and 3.5 volts, respectively, which would produce proportionally increasing current when a contact is shut. The magnitude of the detected current at any given output lead is then determined by the row(s) in which the closed contact(s) 1310 is located.

In some embodiments, every contact 1310 of the sensor 1300 contains a unique pair of electrical leads allowing the system to determine when each individual contact is closed. The system can determine the total number of closed contacts at a given moment. Dividing this number by the number of total contacts on a mat will provide the percentage of the shelf space stocked with product.

Knowing both the rows and columns in which contacts are closed allows the detection of a product's footprint. Combining the detection of the footprint and weight of a product allows for better inventory control than a system which detects the presence of products, product footprints or product weights alone. The detected size and weight can be compared to the expected footprint and weight of the product assigned to a particular section of the self and indications of any abnormalities sent to store employees. The expected product data may be contained in a product database. In a system which detects only the presence of the product(s) in a sensor region, only coarse measurements of the product inventory can be made. Here, the provide indication is a binary: the product is present or it is not. When the system has the additional ability to detect the footprint of a product, a better approximation of the number of products at the shelf can be made. Additionally, a mismatch of the detected and expected footprint can provide an indication of a mis-stocked product. Further, if the sensor measures the weight of a product the system can detect a misplaced product even if the misplaced product has the expected footprint. Additionally, the system can detect when a misplaced product has been stacked on top of the expected, assigned products.

In some embodiments, the sensor can be trimmed to fit a shelf, a product size or as limited by some other requirement. The sensor can be easily trimmed due to the manner in which it is constructed. Supply and return leads may be located together along a single edge of the sensor. Since the return path for any current proceeds through the contacts, the contacts will function as designed so long as the conductors between the shut contact (along the return path) and the electrical leads are not severed. Removing conductors and/or contacts which are not between the shut contact and the leads has no effect on the supply or return paths. This allows the removal of excess rows or columns without impacting the function of the remaining contacts.

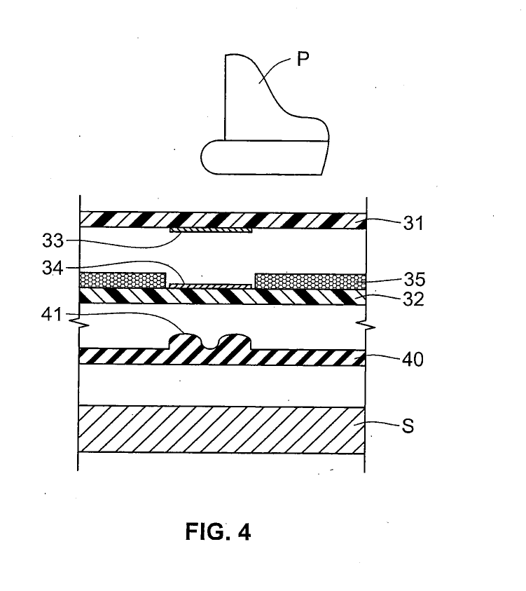

With reference to FIG. 4, a third layer 35, in some embodiments formed of plastic foam, maintains a space between the opposed conductive contacts when the sheets 31 and 32 are in their normal, unflexed condition. The third layer 35 has multiple apertures that are aligned with the contacts 33 and 34 to permit those contacts to be moved into and out of engagement with each other, as can be seen in FIGS. 4-6. Other suitable types, sizes and shapes of the spacer material may be used so long as the spacer material does not interfere with the operation of the contacts.

The third layer 35 may be granulated and/or contain channels to allow for the flow of air between the contacts. Without air flow between the contacts, a suction or vacuum may form between the layers 31 and 32. When a product is placed on the sensor 30 air is forced out from the compression of layers 31 and 32 together. If air is not allowed to reenter the region from which it was displaced near the closed contact, a vacuum is formed in the vicinity of the contact. This vacuum may be sufficient to prevent the reopening of the contact upon removal of a product, even considering the resiliency of the layers and the third layer 35, thereby providing a false indication of a product being located on a shelf. The granulated and/or channeled third layer 35 mitigates this problem by allowing the free flow of air within the sensor 30 to break any vacuum which may form.

In some embodiments, the resiliency of the third layer 35 and/or layers 31 and 32 can be engineered such that a specified minimum weight is required in order to close a contact. This may be particularly helpful in preventing false-positives of stocked shelf if a misplaced, lighter product is placed on the sensor 30. Such an embodiment provides some of the advantages of a contact capable of accurately measuring the weight of a product in a simpler form.

Beneath the lower sheet 32 is a bottom sheet 40 which rests on the top surface of the shelf S. Bottom sheet 40 forms multiple raised annular biasing regions 41 on its upper surface, with each annular biasing region 41 cooperating with at least one of the conductive contacts 34 on the lower sheet 32 to bias the conductive contact 34 on the lower sheet 32 towards the conductive contact 33 on the upper sheet 31 when a product is placed on the sensor. The biasing regions increase the sensitivity of the sensor to allow it to differentiate between products having only slight difference in weight (approximately tenths of an ounce). The size and shape of the biasing region may be selected as a function of the size and shape of the conductive contacts, the spacer material, the top and bottom sheet material, and the desired sensitivity of the sensor.

FIG. 5 shows the positions of the contacts 33 and 34 and the annular biasing regions 41 when there is no product P resting on this particular pair of contacts, so there is no weight applying downward pressure on the sensor. It can be seen that the contacts 33 and 34 are spaced apart from each other, so that no electrical current can flow across this particular pair of contacts when no product is present.

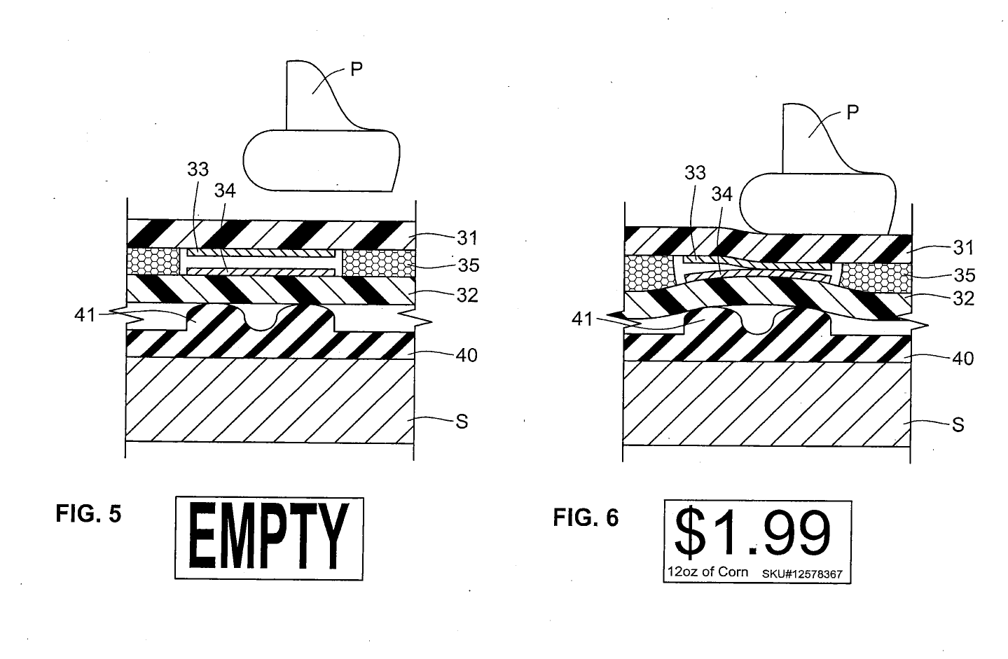

FIG. 6 illustrates the change that occurs when a product P is resting on the upper surface of the laminate in the location of this particular pair of contacts. It can be seen that the weight of the product P bearing down on the laminate presses the sheets 31 and 32 downwardly against the raised annular biasing region 41 of the bottom sheet 40, which cause the sheet 32 to be flexed upwardly, thereby raising the lower contact 34 into engagement with the upper contact 33 to form an electrical path. This closes the “switch” formed by the contacts 33 and 34, and thus electrical current flows across through this pair of contacts, indicating that the product P is present in this region of this particular shelf S.

As long as a product P is resting on a shelf somewhere within the area covered by any given weight sensor (e.g., weight sensor 30a), current will be conducted through at least one pair of contacts 33 and 34 in that sensor. For example, when the voltage across the leads to each sensor is 3.3 volts, the current through a 200 K-ohm pull-up resistor is 17 μA, and this current through each sensor can be separately monitored by the controller 28 connected to the conductor loop 23 via the conductors 21 and 22. The presence of the current in any given sensor indicates that the shelf area covered by that sensor is not out of stock.

When all the contact pairs 33, 34 in that shelf area are open, the controller 28 detects no current flow through that weight sensor 30, which indicates that shelf area is out of stock, and the controller 28 can generate an alert signal indicating an out-of-stock condition. This alert signal may, for example, be transmitted to the electronic shelf label 10 corresponding to this particular shelf location to cause that electronic shelf label 10 to display “EMPTY,” as illustrated in FIG. 5, or another appropriate message. In some embodiments, electronic shelf label 10 includes at least one indicator light which energizes upon receiving the alert signal to indicate a product is out of stock. The alert signal can also be transmitted to a central controller or computer to alert store personnel that an out-of-stock condition exists at this particular shelf location. The alert signal can be implemented using email, text messages, phone calls, and computer notifications. In some embodiments the alert signal provides notification when the inventory of a retail product on the store's shelf falls below a predetermined number, so that store employees can re-stock the product before it becomes out of stock on the shelf.

It will be understood that the controller 28 can be programmed to generate an out-of-stock condition in response to the detection of a zero-current condition in any single weight sensor 30, or any combination of weight sensors 30 covering a shelf area allocated to the same product. Thus, the alert signal can indicate an out-of-stock condition for any desired shelf area or any desired product, depending upon how the controller 28 is programmed.

In some embodiments, the output current and/or voltage from a sensor 30, used to detect the presence of products, is transmitted to the ESL 10 associated with that particular sensor. The ESL 10 may process the sensor 30 output to determine when an out of stock or low-stock condition occurs, calculate the precise inventory on the shelf, or detect the presence of misplaced products. The ESL 10 may be used to process changes in the inventory status at any given moment. The ESL 10 may then send an alert of this condition to the area controller 28 for subsequent distribution to store employees and/or updates to inventory management databases. This embodiment may save bandwidth between the area controllers, sensors and ESLs by transmitting on the network only when a change in the inventory occurs rather than continuously transmitting signals to be processed by a separate device.

Additionally, the ESL may be capable of buffering a number of different displays to be shown in the event of change in the inventory status without requiring a display-change signal to be transmitted from the area controller, or other component, to the ESL, further saving network bandwidth. This buffering may also allow the ESL to switch between empty/out of stock and product information displays when the product is returned without the need for network communications. The output signal of sensor 30 may be directly processed by the ESL which directly controls its display. Alternative, this buffering function may be performed by another component in the inventory network such, e.g., as a connector 29 or area controller 28.

In some embodiments, the display shown by an ESL can be determined by the inventory status. For instance, in an out of stock condition the ESL may display a QR code or other display which can be scanned by the customer to process a rain check or provide a coupon for missing item, schedule a delivery of the item to the customers residence or send an email to customer when the item is in stock. The display may also indicate other locations in the store in which the same or similar item can be found. For example, if all items have been taken from a promotional display nearer an entrance to the, the promotional display ESL could indicate the aisle on which the same (or a competitor) item is currently located, thereby allowing the customer to quickly find the product. The display may also indicate when replacement products are scheduled to be in stock or if more are in the store's back room.

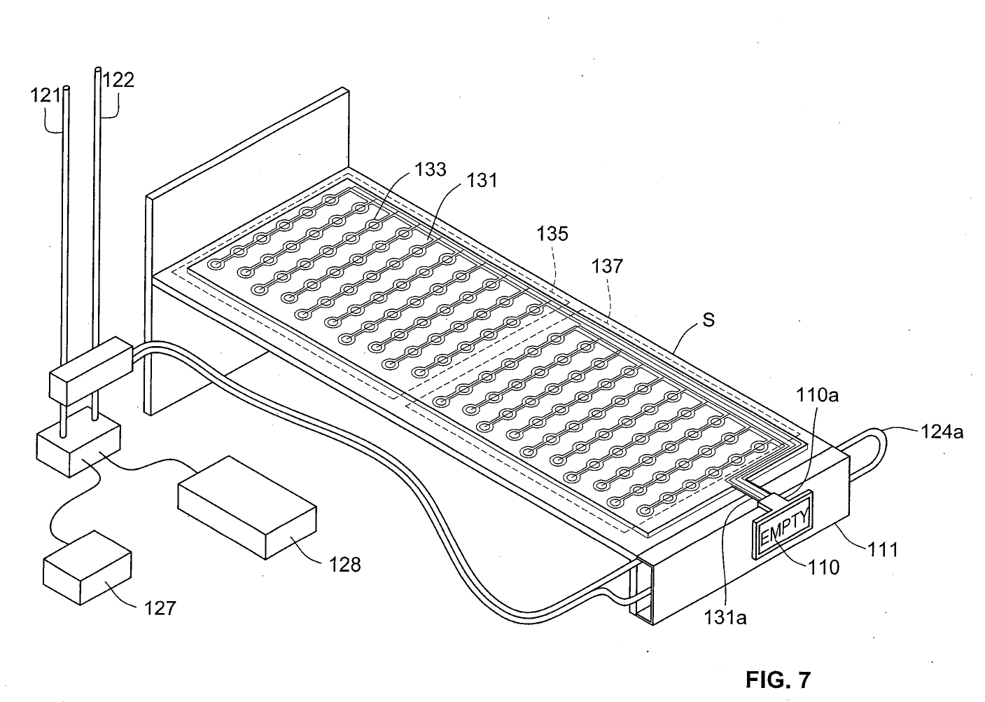

FIG. 7, illustrates an alternative arrangement that requires only the front conductor loop 124a, ending along the length of the interior of the front rail 111. This loop 124a is coupled to a power supply 127 and a controller 128 via coupler 129 and a pair of vertical conductors 121 and 122. A pair of sensors 130a and 130b cover respective front and rear sections of the illustrated shelf area, but the leads for these two sensors are located at the front edge of the shelf S, where those leads are plugged into a jack 110a on the back of the electronic shelf label 110. This arrangement eliminates the need for a rear rail on the shelf, because all the electrical power and communication signals, to and from sensors 130a, 130b and the electronic shelf label 110, are transmitted via the single primary winding formed by the loop 124a and the secondary winding on the back of the electronic shelf label 110.

In some embodiments, the front rail conductor loops and supporting hardware may be removed by transmitting all communication and power signals through the rear rail. These communication and power signals may be passed to the ESL through the sensor. In some embodiments, all inductive coupling components may be located in or near the rear rail with communication and power signals being sent directly to the end component from these inductive components.

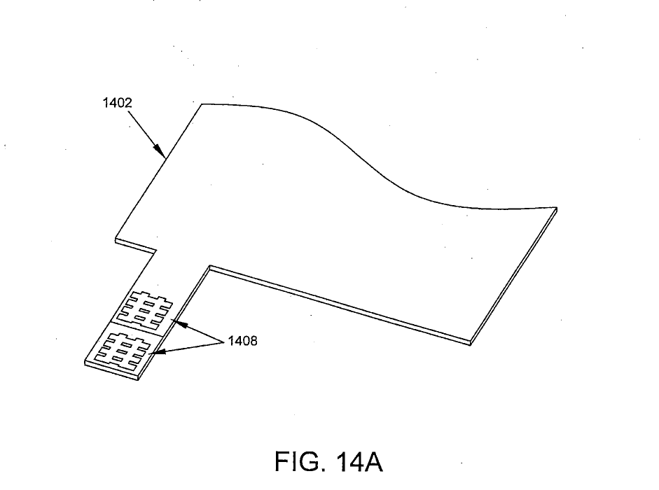

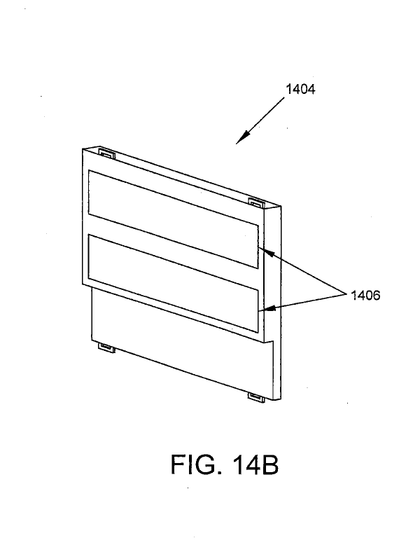

FIGS. 14A and B illustrates a means by which inputs and/or outputs to a sensor 1402 can be made via a ESL 1404. Referring to FIG. 14B, the ESL 1404 may comprise a pair of metal strips 1406 on the rear face of ESL. The metal strips 1406 are connected to an input/output pin (not shown) on the processor of the ESL 1404. These strips 1406 align with contact strips 1408 of the sensor 1402 (shown in FIG. 14A). The contact strips 1408 may be disposed on a tail or flap of the sensor which can be feed through a rail used to hold the ESL 1404. This rail may also contain the primary and/or secondary windings used to provide communication and power to the ESL 1404, which then may be transmitted to the sensor 1402 by the ESL 1404. Alternatively, the primary and/or secondary windings may be located at the rear of a retail shelf and may be connected to the sensor 1402-ESL 1404 pair at the rear of the sensor 1402. In this embodiment, the power and communications signals may be provided via inductive coupling to the sensor 1402 which transfers these signals to the ESL 1404 via the output contact strips.

In the above-described embodiments, the weight sensor 30 is configured to be in either a ‘closed’ state—meaning retail products are on the sensor and the sensor senses their weight—or an ‘open’ state—meaning there is no weight on the sensor and indicating an out-of-stock product. In further embodiments, weight sensor 30 is configured to provide more detailed information to an inventory management system. For example, by measuring the weight of retail products on the shelf and knowing the weight per product, the sensor provides an inventory management system with a count of the retail products on a shelf In some embodiments, weight sensor 30 is accurate to 0.1 oz.

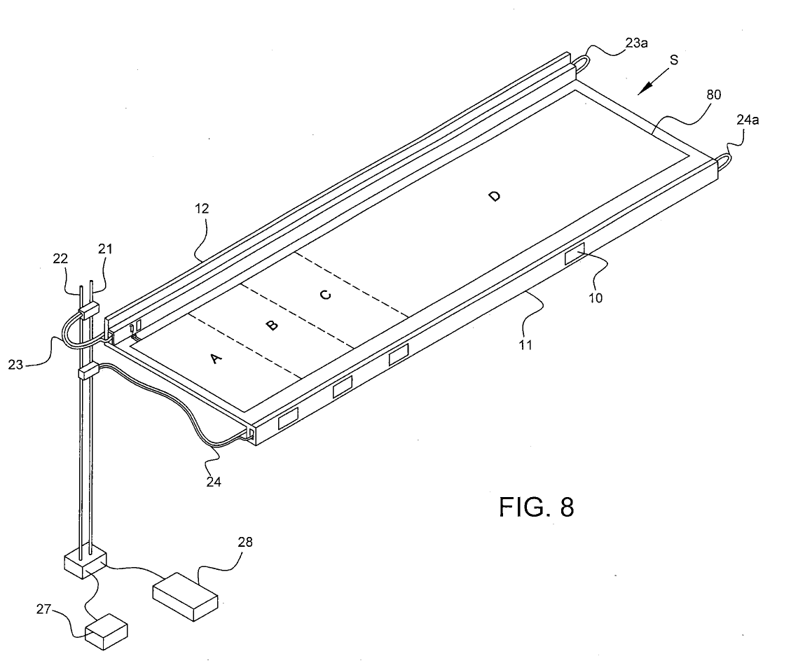

In some embodiments, the weight sensor is programmable to be divided into discrete regions. FIG. 8 shows a weight sensor 80 divided into regions A, B, C, and D. Controller 28 assigns parameters to each region based on the retail product that will be stocked in that region. Weight sensor 80 thus serves to monitor inventory of multiple retail products simultaneously. As discussed in more detail below, regions A, B, C and D each may be assigned different products, and an electronic shelf label 10 may be associated with each region to provide pricing and product information for the products on its associated region.

In one embodiment, the sensor may employ circuitry which produces a signal representative of the weight of the products placed on the sensor. Circuitry suitable for such measuring include variable resistive elements and strain gauges. In operation, a region of the sensor can be identified for a specific product. For example, the inventory system may include a database of product specific information including universal product codes (UPC), product numbers, individual weight of the product, source or manufacturer, expiration date, and pricing information. A user interface can be used to identify the product that is associated with the sensor region.

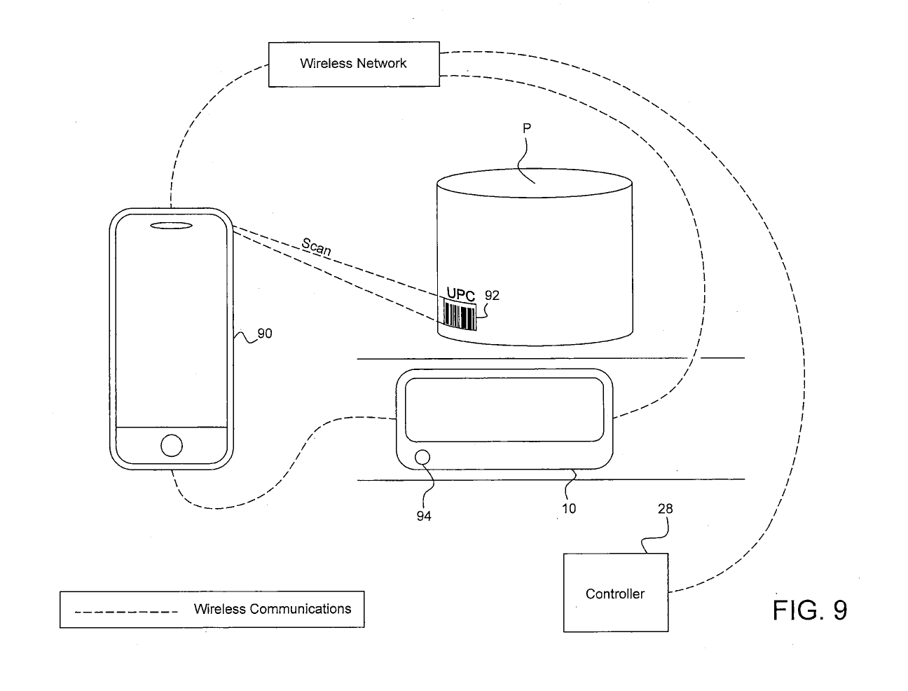

In one embodiment, such as that illustrated in FIG. 9, electronic shelf label 10 includes functionality to scan the UPC bar code 92 contained on a product P. The electronic shelf label 10 may be in communication with the product database and can access the individual weight associated with the product specified for that region. Electronic shelf label 10 may have functionality to determine an inventory of the products contained in the region using the measured total weight from the sensor and the individual weight of the product. The inventory count may be displayed on the electronic shelf label 10. The individual inventory count functionality may reside in the electronic shelf label 10, in the controller 28, or in a separate designated processor, or the functionality may be distributed among various components of the system. For example, a mobile device 90 (e.g.—a smart phone or other mobile or portable device) may be used as a user interface to communicate with the electronic shelf label 10, or controller 28 to identify the product P for a specific region of the sensor. The mobile device 90 may have scanning technology to automatically capture the UPC bar code 92, or the mobile device 90 may receive manual input from the user to identify the product for each sensor region.

An additional advantage of a weight sensor 30 configured to measure the weight of retail products placed upon it is that controller 28 is programmed to identify when a retail product of a weight different than the weight of assigned retail products has been placed on a weight sensor 30. Controller 28 is then able to alert store employees when a retail product has been placed in the wrong area of a shelf either by a stockperson or a customer. For example, if a sensor region is assigned to cans of chicken noodle soup and the product information database indicates that each can of soup weighs 132 grams, electronic shelf label 10 or controller 28 may have circuitry to identify when a product that does not weigh 132 grams is placed on its associated sensor region, e.g., a can of beans weighing 285 grams. The electronic shelf label 10 or controller 28 may also have circuitry to issue an alert of a potential inventory out of place to remotely and automatically notify a store employee of the situation. In another embodiment, the electronic shelf label 10 may include a local indicator 94 such a flashing light or color coded light on the electronic shelf label 10. The local indicator 94 may integrate out of stock, out of place, and low inventory or low stock indications. For example, the indicator light may illuminate yellow if the inventory for the associated region is less than a “low inventory threshold”, it may illuminate red for an out of stock situation, and may flash blue for an out of place inventory.

In some embodiments, the ESL indicator lights and/or display may be used to immediately inform employees and/or customers when an item has been shelved in the wrong location. This feature will help employees quickly fix stocking errors and encourage customers to return items to the correct place on the shelf. In some embodiments, an ESL may inform customers that an item on the shelf may be mis-stocked and that the listed price may be for another item. This feature may help avoid customer confusion as the correct price of an product and/or minimize revenue lost by retailers forced to discount a mis-shelved item in order to satisfy a customer's expectations. In some embodiments, an ESL will display no product information if the system detects a product misplaced on a given sensor.

In some embodiments, the local indicator 94 may be used as an aid to store employees when stocking or restocking retail products to the shelves. An employee scans the UPC bar code 92 of product P that is to be placed on a shelf using a mobile device 90 (e.g.—a smart phone or other mobile or portable device). Mobile device 90 communicates with controller 28 or with electronic shelf label 10, which then cause the local indicator 94 to illuminate in a specified color, indicating to the employee the correct location of the product P. In some embodiments the local indicator 94 may flash or blink to draw the attention of the store employee. In some embodiments the screen of the electronic shelf label 10 will illuminate, flash, or blink to draw the attention of the store employee. This use of the local indicator 94 has the advantage of speeding the process of stocking or restocking retail products by eliminating the need for the store employee to search for the correct location of a retail product. Similarly, this use of the local indicator 94 reduces the frequency of retail products being stocked to the wrong location on a shelf.

In some embodiments, the area controller 28 may reference a database to determine the particular shelf and aisle with which the product (as well as the sensor 30 and ESL 10) has been associated. This information may be communicated to the mobile device 90 by the area controller 28 or other device directly to employees.

In some embodiments, indicator lights are further used to assist customers during shopping. A customer creates a shopping list using a smartphone, tablet, or similar electronic device. Upon entering a retail store, the shopping list is activated and communicates wirelessly with electronic shelf labels 10 or controller 28. As a customer proceeds down an aisle of the retail store, one or more indicator lights of an electronic shelf label 10 associated with a product on the shopping list will illuminate, flash, or otherwise indicate to the customer the location of the desired product. The customer may be directed to the particular aisle on which a product is located in a manner as described above.

In some embodiments, the ESL 10 or area controller 28 is equipped with a short-range wireless communications module (e.g. Bluetooth or IR) to communicate with a customer's electronic devices. After the customer has followed the directions to the aisle or location in which the product is currently located, the short-range communications will then provide an indication to the inventory control system when the customer is near the desired product. At this point the ESL may provide an indication to draw the attention of the customer. This embodiment may reduce the number of indicating ESLs at any moment by only providing the indication when the customer is near the desired product.

In some embodiments, the inventory control system may provide the user unique ESL indications to prevent confusion with other customers who may be using the system. For instance, customers using the disclosed feature may be informed that a particular color or flash of light will occur for her items. The system may comprise a series of speakers which provide an audible indication to the customer, for example the customer's name, when the customer is near the desired product. In some embodiments, video monitors near the customer may provide directions to the desired products or advertisements or other displays tailored to the customer for the particular inventory in the store at that time.

In some embodiments, the inventory system can provide a customer real-time updates as to the product inventory while the customer is in the store or even before arriving. If the inventory of item on the customer's shopping list reaches a threshold, an alert or update may be sent to the customer informing his that the product is low in stock and may not be on the shelf for much longer. Unlike a method which tracks inventory only though the sale of product, the disclosed system more accurately informs the customer if he can expect the product to be on the shelf. This allows customers to prioritize the order in which his shopping will be done and helps mitigate disappointment from the expectation that a not-yet-purchased item is still available.

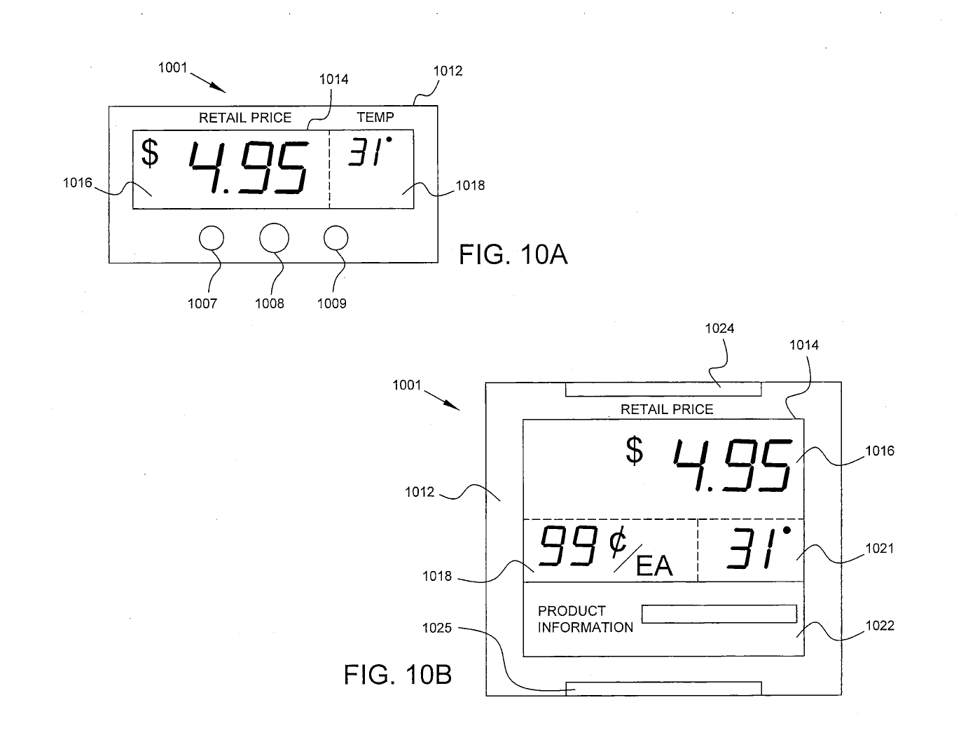

FIGS. 10A and 10B illustrate alternative embodiments of an electronic shelf label (ESL) which may be used with the present disclosure. In FIG. 10A, ESL 1001 comprises various electronic elements disposed within a casing 1012. A display 1014 is disposed on the front face of the ESL 1001 and is divided into a primary display area 1016 and secondary display area 1018. The front face of ESL 1001 further includes a first indicator light 1007, second indicator light 1008, and third indicator light 1009. In some embodiments, the indicator lights 1007, 1008, and 1009 comprise LEDs. In some embodiments, the indicator lights 1007, 1008, and 1009 are green, amber, and red, respectively, which may indicate adequate, low, and out of stock inventory levels, respectively.

At least one or any combination of indicator lights 1007, 1008, and 1009 can be used in place of local indicator 94 described above to assist store employees when stocking or restocking retail products to the shelves. In some embodiments at least one or any combination of indicator lights 1007, 1008, and 1009 may flash or blink to draw the attention of the store employee. Additionally, in some embodiments display 1014 will illuminate, flash, or blink to draw the attention of the store employee.

In FIG. 10B, the display 1014 of ESL 1001 includes primary display area 1016, secondary display area 1018, and tertiary display area 1021. Product information and UPC are displayed on the ESL 1001 via a product information label or display area 1022. A first indicator light 1024 is disposed at the top of front face of ESL 1001 and second indicator light 1025 is disposed at the bottom of front face of ESL 1001. As above, first indicator light 1024 and second indicator light 1025 can be used in place of local indicator 94 described above to assist store employees when stocking or restocking retail products to the shelves. In some embodiments at least one or any combination of first indicator light 1024 and second indicator light 1025 may flash or blink to draw the attention of the store employee. Additionally, in some embodiments display 1014 will illuminate, flash, or blink to draw the attention of the store employee.

In still further embodiments, the weight-sensing apparatus described above is adapted to the unique methods of retail display to additionally indicate out of stock products and track inventory of retail products. Retail displays including peg hooks, product pushers, wire baskets, clothing rods, display racks, and hangars are integrated with weight sensors to detect when an product is out of stock or to maintain an at-the-shelf inventory.

In some embodiments, controller 28 includes a computer processor with software for real-time inventory monitoring. When a product becomes ‘out of stock’—that is, the last of a type of product is removed from a shelf S as sensed by the weight sensor 30—the controller 28 records the date and time of the status change. Similarly, when a product is restocked at the shelf, the controller 28 records the date and time of the status change. Using such information, controller 28 can produce a report for retailers which details the average product out of stock time, time to restock, longest restock time, and the like. The report can also include a percentage of retail store products that are out of stock at a given time or date, or an average out of stock percentage over a given time period.

The weight sensor provides the computer processor with real-time inventory of retail products on the shelves and the computer processor calculates the sell rate or depletion rate of said retail products. Using this depletion rate, the frequency of the need to re-stock said retail products is calculated by the controller, allowing employees to be notified to preemptively re-stock retail products before they become out-of-stock. As an example, the controller is able to calculate low inventory thresholds for the shelves based on depletion rates and provides an alert to store employees indicating the product is likely to become out of stock shortly. This alert prompts store employees to re-stock the product.

The depletion rate can also be used to evaluate the success of various retail product promotional programs. Many retail stores use special shelving displays, eye catchers, and advertisements—both at the shelf and in circulars—to attempt to drive up sales of certain products. If a retail product is sold at two different locations in a store, such as in its normal shelf location and at a special display area, the system provided can measure the depletion rates of this retail product at both locations for comparison to determine the effectiveness of the special display area.

Similarly, the depletion rates of a single retail product can be compared across time. The system can determine the depletion rate in a first week, when an product is not on sale and compare it to the depletion rate in a second week when the product is on sale to determine the effectiveness of sales or promotions. Or the depletion rate of a retail product can be compared from day to day or even hour to hour to better understand sales trends. For example, a certain retail product may be found to sell at a higher rate on weekends, and thus the system may be programmed to issue alerts to prompt store employees to ensure the product is properly stocked on Thursday or Friday rather than waiting for the standard re-stock day on Sunday. In one embodiment, the system can automatically adjust a low inventory threshold as a function of a date or time of day to ensure that sufficient inventory is available for the anticipated demand as a function of the historical depletion rate for the product. Thus, the system is able to maintain historical data for depletion rates for specific products for specific locations for specific dates and times. Historical data from one retail store can be used to identify trends and can be compared against the historical data from other stores to identify anomalies or areas of concern.

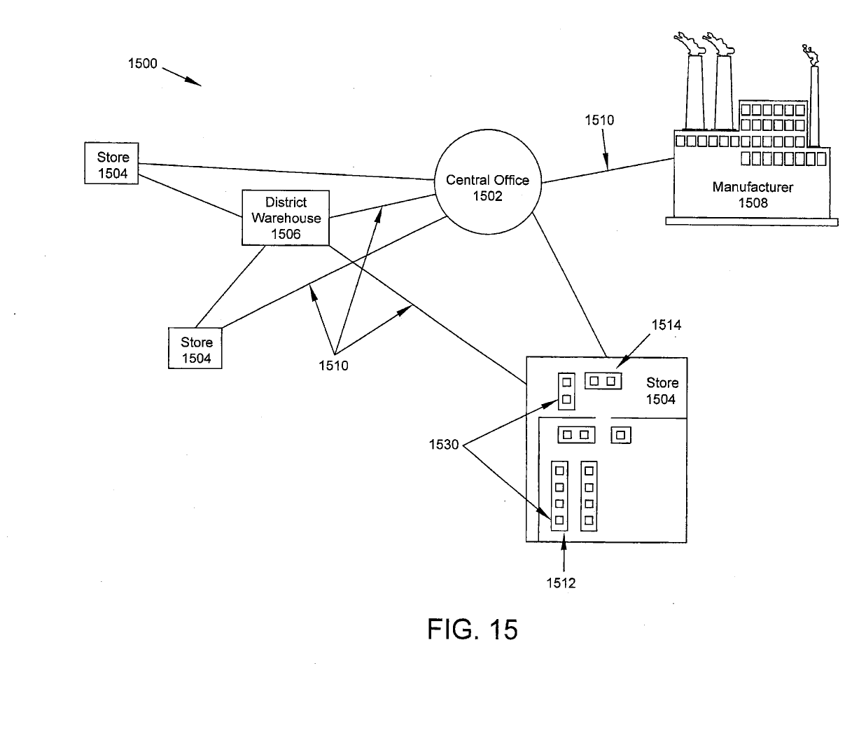

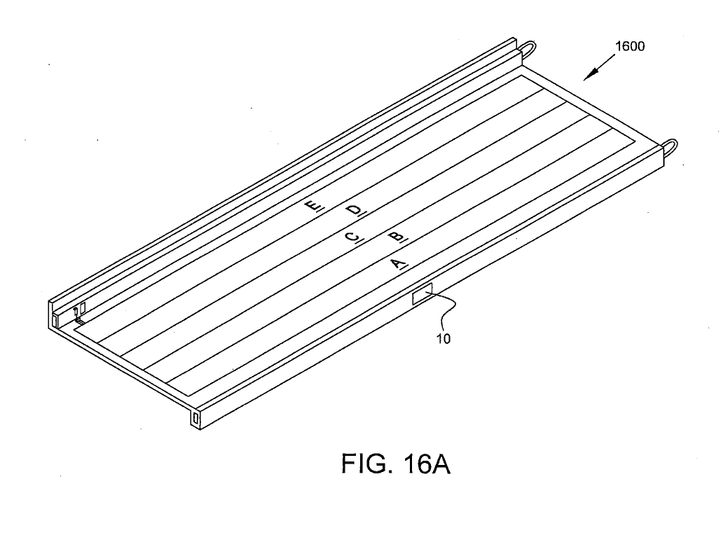

FIG. 15 illustrates an embodiment of an inventory control system 1500. The system comprises a central office 1502, retail stores 1504, and communication links 1510. The communications links 1510 provide for a the transfer of real-time inventory data for each store 1504 to the central office 1502. While the central office 1502 is shown separately from the stores 1504 in FIG. 15, it should be understood that the central office 1502 serves as a collection point for the inventory data (interpreted from the sensor 30 data from each store) and that this functionality may be located or accessed from a different location. This system allows for the real-time tracking of product placement on retail shelves across a network of different retail stores. This allows inventory comparisons across stores to enable real-time analysis as described above.

The stores 1504 each comprise at least one retail shelf 1512 upon which weight sensors 1530 are placed. Some stores may include sensors 1530 in a store- or backroom 1514 to provide a status of the total inventory with the store. The inventory status at a given shelf is detected by the sensors 1530 and transmitted by area and/or system controllers within the store 1504 and then to the central office 1502 via the communications link 1510 (e.g., the internet).

Real-time comparisons of the inventory status between stores facilitates rapid analysis of and changes to product placement. For examples, during the debut of new product and/or special, a retail operator may be able to experiment with various product placement locations at different stores in order to determine which works best. Real-time results will indicate which product locations in a store result in greater product movement. This location information can be transmitted to other stores to inform them to re-stock products in more effective locations.

The removal of products from shelves, and the rate of the removal of products from shelves, can provide retailers with a data set to analyze the effectiveness of the combined product placement design in a manner different from that provide by at the register sale of products.

In some embodiments, the system 1500 includes a distribution warehouse 1506, which may also contain sensors 1530 in order to determine product inventory status at that location. The warehouse 1506 is also connected to the central office 1502 via links 1510 such that its inventory is accounted for. By employing a system in which the inventory at each location within the network is tracked in real-time, nearly instantaneous orders can be accurately placed in order to restock inventory items as needed from locations at which they are available. Additionally, demand forecasting analysis can be performed using this real-time data in order to prioritize to which locations a given product should be sent first.

In some embodiments, the central office 1502 is further connected to a manufacturing or supply plant 1508 such that orders to the plant can be placed dependent on the real-time, at-the-shelf product inventory.

In further embodiments, the system is an at-the-shelf stocking optimizer used to prevent over-stocking of retail products on the shelves of retail stores. The depletion rate is calculated in the manner described above and further used to determine the optimal inventory of retail products on the shelves. The optimal inventory may be calculated automatically based on the depletion rate and restocking cycle. The optimal inventory may be determined by multiplying the depletion rate of a product by the desired or scheduled re-stock rate. For example, if a retail store performs a re-stock of all retail products on its shelves twice a week, the depletion rate can be used to determine how many products should be placed on the shelf at each re-stock to avoid over-stocking the product. As discussed above, over-stocking of retail products at the shelf carries significant inventory costs to retailers. Calculating the optimal inventory of a retail product can free up shelf space for other products and prevent the need to keep higher-than-necessary product inventories in the store's warehouse or storage area and on the store's shelves. Thus, the present disclosure can assist retailers in optimizing their available shelf space.

In further embodiments, the system described above is integrated into an electronic shelf label system, the inventory control system can further provide a dynamic pricing system that will calculate optimal prices for retail products. Given a known inventory of a retail product, the frequency of re-stocking said retail product, and the depletion rate of said retail product, a retail product's price can be adjusted in real time to best match supply and demand of that product. In one embodiment, product database may include pricing levels based on available inventory. As the inventory is depleted, a processor can automatically adjust the price of the inventory on the shelf as reflected in the product database and electronic shelf label 10 will automatically reflect the new pricing.

In some embodiments, electronic shelf labels 10 are used in the back storeroom of a retail store as well as the front retail space. Electronic shelf labels 10 in the storeroom can be linked to electronic shelf labels 10 assigned to the same product located in the front retail space. By creating such a link using controller 28, an electronic shelf label 10 in the back storeroom associated with Product A will illuminate its indicator light when the Product A in the front retail space becomes out of stock as sensed by associated weight sensor 30, providing a visual indication to a retail store employee that Product A needs to be restocked. Once Product A is restocked, as sensed by associated weight sensor 30, indicator light on the electronic shelf label 10 in the back storeroom will turn off.

In some embodiments, the location of a product in the storeroom may be associated with that product in a database maintained and/or accessed by the controller. This association may be formed by associating the product with a particular sensor or ESL which may have already been associated with an aisle, row, shelf or other location in the storeroom. The employee may be informed of the location of the product on a mobile device which may provide general directions (e.g., the aisle on which the storeroom product can be found) in order to more quickly get the employee to the general vicinity of the product.

In some embodiments, the disclosed system is further integrated with a product ordering system. Controller 28 can produce out of stock reports which can be automatically imported into such a product ordering system for ease of ordering replacements. Additional reports are achievable through such integration. For example, a report may indicate which, if any, products in stock on a retail stores shelves are subject to a recall or discontinuation.

In some embodiments, the disclosed system is used to evaluate products for expiration. The database connected with controller 28 includes product-specific information such as expiration date. Controller 28 reviews expiration dates to generate a report of all products which are stocked at the shelf beyond their expiration date. In some embodiments, indicator lights are illuminated to aide store employees in locating expired products. In some embodiments, a report of expired products is sent on a periodic basis to store personnel. In some embodiments, an alert associated with expired products is generated by controller 28.

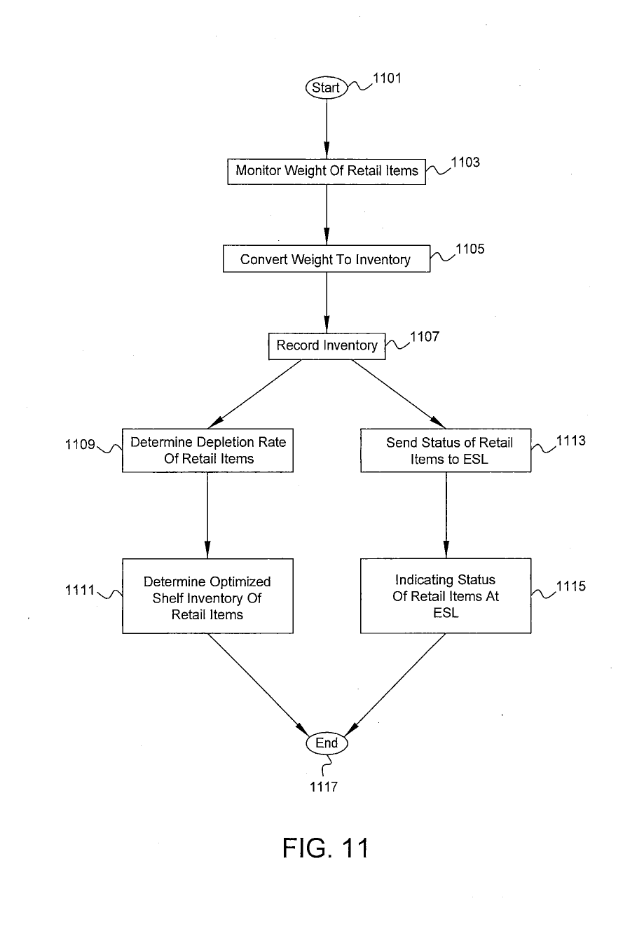

The present disclosure further provides a method for monitoring inventory of a retail item at the shelf. FIG. 11 provides a flow chart for such a method. The method begins at block 1101. The weight of retail items is monitored by a sensor at block 1103, and at block 1105 the measured weight is converted to an inventory of the retail items based on the individual weight of a retail item. This inventory of the retail item being monitored is recorded at block 1107.

At block 1109, a depletion rate is determined for the retail items by monitoring inventory over a predetermined period of time. This depletion rate is used at block 1111 to calculate an optimized shelf inventory. The optimized shelf inventory is determined using the depletion rate and a predetermined frequency of re-stocking a retail item at the shelf. As discussed above, optimized shelf inventory is desirable to prevent both over- and under-stocking a retail item.

At block 1113 the status of the retail item is sent to the ESL associated with that retail item. The status can be in stock, low stock or low inventory, or out of stock. At block 1115 the ESL indicates the status of the retail item. The method ends at block 1117.

In some embodiments, the inventory of a retail product or the depletion rate of a retail product are sent to a remote location (i.e. a location outside the retail store). For example, the inventory or depletion rate or a retail product can be sent to a central processor, a corporate headquarters, a supply chain warehouse, a manufacturing facility, or a third party monitoring facility. The dissemination of inventory and depletion rates can be used to improve supply chain management and inventory planning.

Thus, the disclosed apparatus and system provide a comprehensive inventory control system for retail products. A weight sensor placed on retail shelves and a controller together monitor real-time at-the-shelf inventory of retail products and provide out-of-stock alerts, low inventory alerts and out of place inventory alerts. The controller may calculate a depletion rate for each retail product, allowing the system to anticipate out-of-stocks and alert employees to pre-emptively re-stock the product. The controller further is capable of evaluating depletion rates across locations within a store and across time. The inventory control system can further track and compare the inventory status of multiple retail locations. By collecting this data, required inventory—both at the shelf and in a store's warehouse—may be calculated. Finally, dynamic pricing is enabled by the inventory control and electronic shelf label systems. The product database can maintain historical data for each product based on shelf location and can assist in defming new metrics and identify trends that may be used to further optimize inventory control and shelf space availability to effectively employ just-in-time inventory while enhancing the effectiveness of valuable, but limited, retail shelve space.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, app, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network or as an app on a mobile device such as a tablet, PDA or phone.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer or mobile device. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor or other monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. An inventory sensor comprising:
a plurality of first conductive elements, each disposed in a first layer and connected to an electrical supply line;
a plurality of second conductive elements, each disposed in a second layer and aligned such that each second conductive element opposes one of the plurality of first conductive elements, each second conductive element connected to a unique electrical return line;
wherein each of said plurality of first conductive elements are adapted to move into contact with the respective opposing second conductive element when force is applied to said first conductive element in the direction of second conductive element; and
wherein said electrical supply line and said unique electrical return line for each of said plurality of second conductive elements are connected to a controller which monitors each unique electrical return line to determine a footprint associated with a retail item placed on said inventory sensor, and wherein said controller compares the determined footprint to a database of stored retail item footprints to identify the retail item placed on said inventory sensor.

2. The inventory sensor of claim 1 wherein said controller monitors each unique electrical return line to determine a quantity of footprints associated with the retail items placed on said inventory sensor.

3. The inventory sensor of claim 1 wherein said controller additionally determines the weight of the retail items placed on said inventory sensor.

4. The inventory sensor of claim 3 wherein said controller compares the determined retail item weight to a database of stored retail item weights to determine a quantity of retail items placed on said inventory sensor.

5. The inventory sensor of claim 4 wherein said controller performs a lookup in said database for the identified retail items to determine a predetermined low inventory threshold associated with said retail item and generates a warning when the determined quantity falls below the predetermined low inventory threshold.

6. The inventory sensor of claim 5 wherein said controller monitors each unique electrical return line to determine a quantity of footprints associated with the retail items placed on said inventory sensor and wherein said quantity of footprints, said determined retail item weight, and said determined quantity of retail items are cross-referenced to identify an out of place retail item condition.

7. The inventory sensor of claim 6 wherein a visual indication is generated at the inventory sensor or at an associated display when a retail item having a non-matching footprint or non-matching weight is detected at the controller on the inventory sensor.

8. The inventory sensor of claim 1 further comprising a third layer disposed between said first layer and said second layer to provide biasing such that each of said plurality of first conductive elements and each of said plurality of second conductive elements are not in contact when force is not applied to said first conductive element in the direction of second conductive element.

9. An inventory sensor comprising:
a plurality of opposing contact pairs, each opposing contact pair comprising a first contact disposed in a first layer and a second contact disposed in a second layer, wherein each opposing contact pair is biased such that said first contact and said second contact are not connected, said biasing provided by a third layer disposed between said first layer and said second layer;
wherein each of the plurality of first contacts is electrically connected to one of a plurality of supply lines and each of the plurality of second contacts is electrically connected to one of a plurality of return lines;
wherein each of said first contacts, said second contacts, said supply lines and said return lines are formed from conductive material, such that bringing one of said first contact and one of said second contact into connection forms a conductive path comprising the supply line, the first contact, the second contact, and the return line;
wherein said first layer, said second layer, and said third layer collectively form a mat having a forward edge facing a front edge of a shelf, with said plurality of opposing contact pairs arranged into a plurality regions in said mat, said plurality of regions arranged transverse to a forward-aft axis of said mat; and
wherein each of the plurality of supply lines and each of the plurality of return lines are connected to a processor for determining a footprint associated with a retail item placed on said mat.

10. The inventory sensor of claim 9 wherein the processor determines in which region of said plurality of regions said retail item is located.

11. The inventory sensor of claim 9 wherein said processor determines a quantity of footprints associated with the retail items placed on said mat.

12. The inventory sensor of claim 9 wherein said processor compares the determined footprint to a database of stored retail item footprints to identify the retail item placed on said mat.

13. The inventory sensor of claim 11 wherein said processor transmits the determined quantity of retail item footprints to a display associated with said mat.

14. The inventory sensor of claim 9 wherein each of said plurality of second contacts is electrically connected to one of a plurality of return lines which is unique to that second contact.

15. The inventory sensor of claim 9 wherein said third layer comprises a granulated material adapted to permit air flow between opposing contacts of opposing contact pairs.

16. The inventory sensor of claim 11 wherein said processor is disposed within an electronic shelf label electrically connected to said mat.

17. The inventory sensor of claim 9 wherein the bringing one of said first contact and one of said second contact into connection to form a conductive path is caused by placing a retail item on said mat.

18. The inventory sensor of claim 11 wherein said processor generates a warning for store personnel when the determined quantity of retail item footprints falls below a predetermined threshold.

19. The inventory sensor of claim 11 wherein said processor generates an alarm for store personnel when the determined quantity of retail item footprints is zero.

20. The inventory sensor of claim 11 wherein said processor is disposed with said mat, and wherein said processor is inductively coupled to an inventory control system.
